(19) United States
(12) Patent Application Publication
(10) Pub. No.: US 2002/0111845 A1
(43) Pub. Date: Aug. 15, 2002

(54) Online meeting planning system with 3-node configuration

(76) Inventor: Leighton K. Chong, Honolulu, HI (US)

Correspondence Address: LEIGHTON K. CHONG, OSTRAGER CHONG & FLAHERTY (HAWAII), 841 BISHOP STREET, SUITE 1200, HONOLULU, HI, 96813, US

(21) Appl. No.: 09/954,442

(22) Filed: Sep. 13, 2001

Related U.S. Application Data
(60) Provisional application No. 60/232,940, filed on Sep. 15, 2000.

(51) Int. Cl. G06F 17/60

(52) U.S. Cl. 705/8

(57) ABSTRACT

A 3-node online meeting planning system includes a secure computer as a first node which is protected from unauthorized access running a meeting planner application program for entering meeting planning data which includes sensitive data of persons authorized as attendees at a meeting event and non-sensitive group data, a public online site as a second node which receives only the non-sensitive group data uploaded from the first node and assembles a unique meeting group program for the group using the non-sensitive group data, and a private online site as a third node which receives the assembled meeting group program from the second node and the sensitive data downloaded from the first node and combines them in an online private meeting group site accessible only to authorized attendees of the meeting event. Using this 3-node system, the meeting planner at the secure computer can retain control of the sensitive data, while using the non-sensitive group data for resource browsing and meeting planning functions on the public online site, which may be an ASP meeting planner portal which has an interface and navigation schema familiar to meeting planners and provides high-powered search tools and links to other public sites. The private meeting group site can be made the hub for a wide range of transactions, fulfillment functions, and group communications functions for the meeting event.

### SPECIFICATION

This U.S. patent application claims the priority of U.S. Provisional Application No. 60/232,940 filed on Sep. 15, 2000, of the same title, and of which the present inventor was one of the named joint inventors.

### TECHNICAL FIELD

This invention generally relates to an online system for group meeting planning, and more particularly, to one that provides facilities online for efficiently planning, booking, transaction and fulfillment of group travel arrangements and meeting activities at a local destination.

### BACKGROUND OF INVENTION

Since the Internet was opened to the public in 1993, the highest commercial usage of it has consistently been for travel, i.e., purchasing airline tickets, renting cars, reserving hotel rooms, and obtaining information on and making arrangements for local activities at the destination. As more and more users have discovered the convenience and power of obtaining information and comparative pricing on the Internet, demand has increased for travel suppliers and distribution intermediaries to become more transparent with information, to offer customers more advantageous pricing, and to share savings and discounts for online purchases and group bookings. Travel companies have responded by offering users more information, greater selection, and greater functionality and convenience in using their web sites. Today, airlines, hotels, car rental agencies, travel agencies, travel portals, travel-related online merchants and other distribution intermediaries are embracing the Internet as one of the most efficient and far reaching delivery systems for travel services and products.

Travel is one of the largest indirect service expenses for businesses, and corporate travel and meeting planning managers are demanding even greater efficiencies and savings in the use of online travel services. Forester Research estimates that business spending for online travel services will reach $38 billion in 2003, and nearly one-third of the total will be purchased by corporate travel managers using managed purchasing solutions. In industry surveys, 82 percent of travel managers at large “early adopter” companies said they will buy all of their travel online by 2001. Internet-based travel services have responded, through consolidations and industry partnerships, with attempts to assemble the widest reach of travel services at the most advantageous pricing schedules to address the needs of this important market segment. An example of an Internet-based travel booking service that offers searching of consolidated databases of travel services, prices, and schedules is Bistravel.com, headquartered in Philadelphia, Pa.

With increasing competition, falling prices, and lowered profit margins, online travel systems have had to include increasingly sophisticated functions and data intensive solutions, particularly for corporate travel managers. Online services are increasingly leveraging the advantages of an Application Service Provider (ASP) model to offer a completely outsourced, travel purchasing solution to users. The ASP model provides low implementation and maintenance costs at the user end and services delivered at high performance levels. An example of an online corporate travel booking site using the ASP model to provide sophisticated travel planning functions for corporate travel is GetThere.com, headquartered in Menlo Park, Calif.

The travel booking ASP allows users with password authorization, including company employees connecting through a company intranet, to link to a travel planning site hosted on a secure ASP server and search extensive databases of products and services offered by travel suppliers and distribution intermediaries for booking arrangements. While some ASP sites attempt to protect user data with password access or, in some cases, even encryption, they essentially are public sites because of the large number and diverse types of buyers and sellers that such consolidated sites try to bring together. The current ASP model thus has the disadvantage that it requires users to enter and store sensitive identification, personal, and financial information at the ASP site in order to enable the ASP provider to handle booking arrangements. Corporate travel managers are particularly reluctant to store employee data and company financial information at a web site that is not under their complete control.

As corporate travel bookings become increasingly commoditized, corporate travel managers increasingly want to integrate routine travel booking functions with other important functions they have responsibility for, such as the planning of corporate meetings, conventions, and exhibitions, targeting incentive travel to employees and preferred clients or customers, and making detailed hospitality and leisure activity arrangements at local destinations where such events are held. These types of detailed meeting planning functions and destination arrangements have heretofore been handled by corporate meeting planners (CMPs) largely by telephone and direct personal contacts with local hotels, convention centers, vendors, service providers, etc. Some software packages have been developed which allow corporate meeting planners to manage lists of participating employees, company travel information, and planned local events and activities on a secure PC in a corporate intranet or standalone system. The output of these types of meeting planner software is usually in the form of printed lists which can be used by the meeting planner to organize the various activities. An example of such meeting planner software is the PlanItDirect™ software offered by Destination Software, Inc., of Wailuku, Maui, Hi.

Where the local meeting arrangements are complex, the corporate meeting planner may hire a travel planning consultants (TPC) or destination management company (DMC) to organize the local arrangements, or may work directly with the hospitality or events manager of the hotel or host site where the event is to be held. For corporate incentive travel and client promotion events, an incentive company (ICO) may be hired to put together an employee or client-themed event that reflects the corporate purpose in providing the incentive reward. All of these types of planning functions require the handling of personal employee or client data and/or company sensitive information which corporate meeting planners want to have tightly controlled in-house or released only to trusted contacts. Corporate travel managers and meeting planners have therefore been reluctant to upload and store such information with service companies via Internet, even at sites that are supposedly secure.

When group meeting events are transacted and fulfilled at the physical host site, it is very desirable that the personal employee or client data and/or company sensitive information assembled by the meeting planner during the planning of the event be able to be re-used for the countless activities and transactions encountered at the actual event. In this way, manifest lists of participating attendees can be prepared, updated, and sent to responsible persons without having to continually re-input the data for every activity. Similarly, it is desirable that conference materials, syllabi, notes, email, group messages, proceedings, and communications in general for that event, much of which is assembled by the group meeting planner beforehand, be made available online to authorized participants but secured from unauthorized persons.

Some online ASP services, such as Event411.com, based in Marina del Rey, Calif., offer sophisticated meeting planning and site hosting functions that allow groups to plan a meeting online and have the meeting information available online to participants of the meeting through a hosted group meeting site with personal web pages listing schedules and activities for each participants. However, such ASP services are accessed on the public Internet and may be vulnerable to unauthorized access, and typically require that users surrender all rights to the content that they post online.

### SUMMARY OF INVENTION

It is therefore a principal object of the present invention to provide a system in which a meeting planner can enter personal, identifying, company, or other sensitive data in the planning of an event using facilities and resources accessed through the public Internet, and yet have control of the sensitive data to secure it from access by unauthorized persons. It is a further object that the meeting planner be able to incorporate the sensitive data with sophisticated meeting facilitation functions that are accessible online to participants of the event, and yet keep the sensitive data secure from unauthorized access.

In accordance with the invention, an online meeting planning system is comprised of:

(a) a first node which is a secure computer protected from unauthorized access having a meeting planner application program for entering meeting planning data which includes: (i) personal, identifying, or other sensitive data of persons authorized as attendees at a meeting event; and (ii) non-sensitive group data which are unique to a group of authorized attendees at the meeting event and usable for meeting planning and other meeting facilitation functions for the group;

(b) a second node which is a public online site which receives only the non-sensitive group data uploaded from the first node and assembles meeting planning and other meeting facilitation functions in a unique meeting group program using the non-sensitive group data; and

(c) a third node which is a private online site which receives the assembled meeting group program downloaded from the second public node and the sensitive data of authorized attendees downloaded from the first secure node and combines the authorized attendee data together with the meeting group program to create a private meeting group site accessible only to authorized attendees of the meeting event.

In a preferred embodiment of the system, the first node is a secure PC on a corporate intranet or standalone system behind a firewall which is used by a meeting planner to enter the sensitive data and non-sensitive group data for a planned meeting event. The second node is a public ASP site on the Internet which can assemble meeting planning and meeting facilitation functions for the group, such as generating attendee lists, activity participant lists, detailed meeting schedules, searchable meeting databases, attendee email, telephone number, and room number directories, attendee messaging, conference calling, and teleconferencing functions, e-commerce functions for attendees to make local activity arrangements, etc. The third node is a private meeting group site hosted on a local server in network proximity to the meeting event location or physical host site for high-speed, high-bandwidth access by authorized users. A system intermediary under control of the meeting planner can be provided to monitor the progress and control the flow of programs and data among the 3 nodes of the system.

Using this 3-node system, the meeting planner at the secure intranet PC can retain control of the sensitive attendee data and only downloads it to the local meeting host server for access by authorized users during the meeting event. The meeting planner can use the sensitive attendee data to conduct manual or online travel booking arrangements from the secure intranet PC. The meeting planner uploads only the non-sensitive group data to the public ASP site for online planning and assembly of the meeting group program. The ASP site can link to other public travel aggregator or distribution intermediary sites without compromising any sensitive attendee data. When the meeting group program has been fine-tuned and is ready for use at the meeting event, it is downloaded from the ASP site to the local meeting host server where it can be populated with the sensitive attendee data.

The meeting planner can act as administrator of the hosted group meeting program site and provide different levels of access to users depending on what levels or what activities they are authorized to participate in. Access to the private meeting group site can also be authorized by the administrator for trusted service providers, such as the event manager for the hotel or physical host site, hired meeting planning consultant, incentive company, or destination management company, and/or trusted local vendors. The private meeting group site can be made the hub for a wide range of transactions, fulfillment functions, and group communications functions for the meeting event.

Other objects, features, and advantages of the present invention will be explained in the following detailed description of the invention with reference to the appended drawings.

### BRIEF DESCRIPTION OF DRAWINGS

FIG. 1 is a schematic diagram illustrating the overall architecture of the 3-node online meeting planning, booking, transaction, and fulfillment system of the present invention.

FIG. 2 is a schematic diagram illustrating the wide range of meeting facilitation functions that can be implemented in a meeting group program of the invention.

### DETAILED DESCRIPTION OF INVENTION

The overall concept of the present invention is to employ a distributed data flow methodology for meeting planning data referred to herein as “triangulation”. In this methodology, sensitive and non-sensitive meeting data are generated at a Secure PC (first node) by a meeting planner. The sensitive data are kept under control of the meeting planner and used for executing secure transactions, such as for booking (purchase) airline tickets, renting cars, reserving hotel rooms, etc. for attendees. The non-sensitive data are exported to a Public ASP Portal (second node) that offers high-level meeting planning and facilitation functions. The Public ASP Portal uses the non-sensitive group data to assemble meeting facilitation functions in a unique meeting group program that can be posted at a Private Meeting Group Site (third node) for access by authorized users during the meeting event. The triangulation methodology allows the meeting planner the security of retaining control of the sensitive data, while at the same time assembling a unique meeting group program with high-level meeting facilitation functions from the Public ASP Portal, then combining the sensitive data with the assembled meeting group program at a Private Meeting Group Site so that it can be used for group facilitation and communications functions during the meeting event.

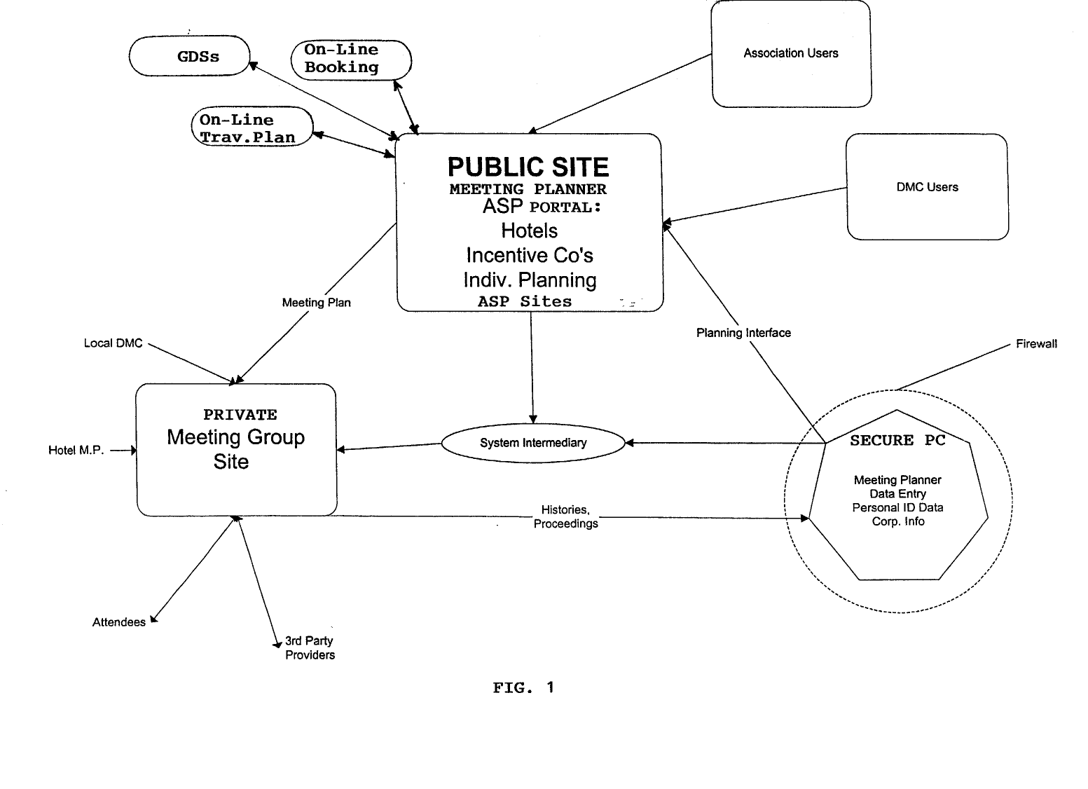

Referring to FIG. 1, a preferred implementation of the 3-node (triangulation) methodology employs meeting planner application software running on Secure PC behind a firewall on a corporate intranet or standalone system as the first, secure node. The meeting planner application software can be of any type that allows data entry of meeting data, including both sensitive data, such as personal and identification information of attendees of a planned meeting event, and non-sensitive group data, such as the event location, physical host site, preferred airline carriers, hotels, number of persons in the group, breakdown by age, gender, and employee/spouse/guest type, etc. The software can be of a very basic type, such as simple word processing or spreadsheet software to set up lists, or more advanced, such as customized meeting planning software that are designed for specific client users, e.g., the corporate travel manager or meeting planner.

For typical corporate use, the Secure PC is a personal computer or workstation connected to a corporate intranet and protected by firewall functions of a network server. Larger companies typically have an in-house staff person, referred to herein as a corporate meeting planner (CMP), whose job function is to plan, organize, and assemble the resources and data for corporate meeting events. Such events can involve a small group to thousands of persons in company meetings, employee incentive events, product or sales promotion events, conferences, etc.

Another type of principal user for the meeting planner software at the Secure PC node is an association meeting planner (AMP). An association typically has hundreds or thousands of members, who fit the profile of “free and independent travelers” (FITs) when traveling for association events. The AMP typically runs the meeting planner software on a standalone system which is secure from outside access. The AMP generally requires more robust meeting planning software to meet the diverse needs of FIT-type travelers. Therefore, the AMP may prefer to perform meeting planning functions on a more robust, public ASP site using only non-sensitive group data (discussed further below), and instead leave it to the individual members to provide their personal data for their own individual airline bookings and hotel reservations.

The Secure PC meeting planner node may also be used by a destination management company (DMC) hired by a corporation or association to organize a meeting event for a group of employees or members at a local destination. The DMC typically runs the meeting planner software on a standalone system which is secure from outside access, and, like the AMP, may prefer to perform meeting planning functions on a more robust, public ASP site using only non-sensitive group data and leave it to the corporate or association travel manager to handle the booking arrangements with personal data from a secure node. Other possible users for the Secure PC meeting planner node include travel planning consultants (TPCs), travel agencies, incentive company planners (ICOs), etc.

The planning for group events typically starts with the selection of the event dates and the destination location of meeting group. The CMP may select event dates by accessing the schedules of key attendees on the company intranet. The meeting location may be selected based upon geographic proximity to the company or the targeted attendees, travel cost data, company preferences for a particular destination, hotel, or physical host site, etc. The CMP assembles the detailed meeting planning data at the Secure PC node facilitated by access to company personnel records, historical meeting planning records, etc. The meeting planning data can include very personal or sensitive employee data, such as names, home telephone numbers, home addresses, email addresses, expense account information, intranet passwords, personal preferences, credit card numbers for non-company expenditures, medical information, required medications, physical restrictions, etc. It can also include company proprietary information, such as new product information, release dates, planned events and announcements, technical product information, planned conference proceedings, meeting costing and budget analyses, etc. In the 3-node system, the CMP can input, manipulate, and maintain control of the sensitive data at the Secure PC behind the firewall for the company's intranet.

An example of a robust meeting planner system for use at a Secure PC for meeting data entry, assembly, and export is the PlanltDirect™ software offered by Destination Software, Inc., of Wailuku, Maui, Hi. The software has two key functions which facilitate implementation of the present invention: (1) exporting a fully-featured meeting group database to a remote online meeting group site for access by the meeting group during the actual event; and (2) cloning of the database for a meeting group to use in the field and then returning the database with modified data for inclusion in the company's master or archive database. These functions are described in detail in U.S. Provisional Application No. 60/232,663 filed on Sep. 14, 2000, No. 60/238,196 filed on Oct. 4, 2000, and No. 60/294,535, filed May 29, 2001, in the names of John Hendrickson, Roxann Hendrickson, and Daniel Baillargeon, the priority of which are claimed in U.S. patent application Ser. No. ______, filed Sep. ______, 2001, which is incorporated by reference herein. In the appended Table I, some of the main advantageous features of the Destination Software meeting planner system are listed.

When the CMP has used the meeting planner software at the Secure PC node to create a tentative meeting plan and proposed attendee list, the CMP may want to do further browsing on the Internet using the powerful search engines and aggregated databases on high-level ASP sites. In the 3-node triangulation concept of the invention, the CMP can browse and do price/cost comparisons on the public Internet sites using non-sensitive meeting group data exported from the meeting group database maintained at the Secure PC node. The sensitive (attendee personal and identifying) data are retained at the Secure PC so that they are not used or stored on the public sites.

The CMP can thus access a much wider range of resources and comparative pricing search engines on the public Internet. Recent public ASP sites aggregate huge volumes of travel data from diverse sources, global distribution services (GDSs) such as Amadeus™, Galileo/Apollo™, and Sabre™, country or local tourist bureaus, travel vendor marketplaces, etc. However, they typically require users to log in by providing identifying account information and entering personal and identifying information for each person in the travel group. For most CMPs, the storing of personal employee and other sensitive data on a public ASP site would be unacceptable. In addition, some of these public ASP sites have explicit Terms of Service policies that require users to relinquish all rights in their data stored on the site.

Therefore, in the preferred implementation of the present invention, a public ASP node is specifically designed as a Meeting Planner ASP Portal which interacts cooperatively with the CMP from the Secure PC to upload the non-sensitive group data and use it for enhanced meeting planning functions. In contrast to consumer-oriented travel sites, the Meeting Planner ASP Portal presents a planning interface and navigation schema designed specifically for group meeting planners and places powerful analyses tools at their disposal. With uploaded data of a tentative meeting plan, including the event location, physical host site, preferred airline carriers, preferred hotels, number of persons in the group, breakdown by age, gender, and employee/spouse/guest type, etc., the CMP can use the public Meeting Planner ASP Portal to conduct very wide-ranging searches of meeting resources and more effective cost/price comparisons. The ASP Portal can construct a group profile from the uploaded non-sensitive meeting group data and use it to search other public Internet sites without having to store any personal data on those sites.

If a unique identifier is needed as an individual handle for each group member, the CMP can assign, and the Public ASP Portal will incorporate, a unique number to each group member. Another type of unique non-personal identifier which conveniently carries over from the CMP's intranet directory would be to use the email handle for the employee with the last 2 or 3 letters of the last name deleted. For example, if the employee's email address in the company directory is “John.Smith@XYZCo.com”, the unique identifier may be truncated to “John.Smi”. The unique identifier handle can be used throughout the meeting planning stage on the Public ASP Portal. Later on, when a meeting plan has been finalized and a functional group meeting program has been assembled by the Public ASP Portal and downloaded to the Private Meeting Group Site, the CMP can download the personal data to the Private Meeting Group Site and the personal ID information can be substituted in for the unique identifier.

Since the selection of the hotel or physical host site and location for the meeting event is an important early decision to be made by the CMP, the Public ASP Portal can arrange to provide links or to host subpages for sponsoring hotels and host facilities on the ASP site. Similarly, corporations often rely on DMCs and ICOs to handle the details of meeting event planning, and the Public ASP Portal can facilitate this selection by providing links or hosting subpages for sponsoring DMCs and ICOs. If a unique identifier is provided for each group member, the Public ASP Portal can provide access to the group members using their identifier handles to browse for information in planning individual activities. For general resource browsing, the Public ASP Portal can serve as a gateway to a wide array of public resources and sites, including GDSs, travel booking sites, travel agencies, other travel planning sites, etc.

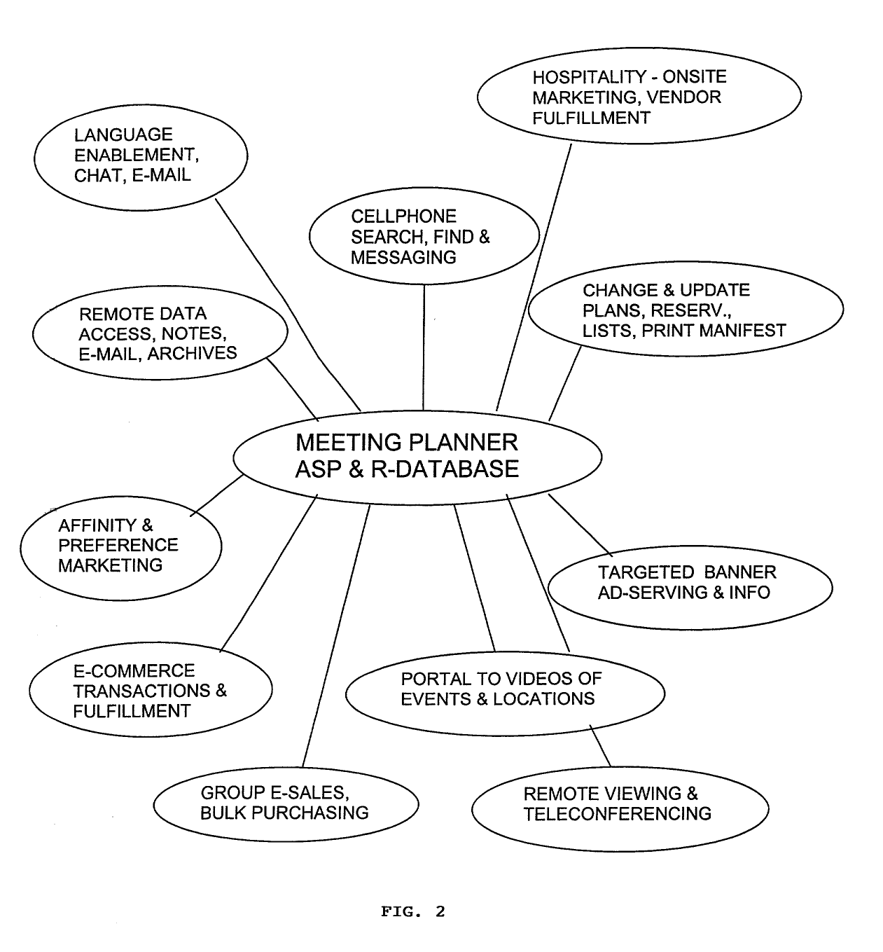

In the triangulation concept of the invention, besides assisting the CMP with resource browsing and high-level meeting planning functions, the Public ASP Portal also performs the important function of allowing the CMP to assemble high-level meeting facilitation finctions for its unique meeting group program to be operated on the online Meeting Group Site during the event. Such meeting facilitation functions can include creating detailed meeting schedules, group and sub-group directories, updating individualized attendee web pages, handling group email, messaging, and other communication functions, e-commerce functions with sponsored vendors, etc. A broader itemization of high-level meeting facilitation functions that can be provided by the Meeting Planner ASP for a meeting group program is shown in FIG. 2. These high-level functions require very robust software programs which cannot be assembled and integrated by the CMP separately. Licensing such programs from an ASP can greatly reduce the capital and implementation costs to the individual company, while providing the most updated technology and specific expertise to the CMP from the ASP site.

ASP sites typically do all the backend work to assemble and integrate the selected program modules to run seamlessly for the client. The client typically only needs to select which meeting facilitation functions it wants for the Private Meeting Group Site to be used during the meeting event. The client selections can be conveniently made online by marking checkboxes for the functions and specifications desired. As these functions are known and commercially available in the IT industry, they are not described in further detail herein. Through the planning interface to the ASP Portal, the CMP is also directed to select the overall appearance, display presentation, and interface options of the pages of the Meeting Group Site from menu choices and standard templates offered by the ASP Portal. When the final Meeting Plan has been assembled by the CMP on the ASP Portal Site, it can then be downloaded to the online location selected by the CMP for the Private Meeting Group site. When the meeting has ended, the meeting group program can be erased by the ASP, or disabled from further use, or saved by the client company for possible future use.

The Private Meeting Group Site in an online site that is not accessible to unauthorized users. At the most simplistic level, it can be a site hosted on a server anywhere on the public Internet that requires a security procedure to validate authorized users, such as using a password. This can be implemented at the lowest cost, but offers only a low level of security. In addition, the response speed and scalability for large numbers of users will be low since accesses and responses will have to travel through the logjams of the public Internet. At a mid-range level, it can be a private site that is unregistered in the public Internet directories that is hosted on a network “edge” server in network proximity to the meeting location. This would greatly increase the speed and scalability of response as the site could be accessible only “one hop” away from the user's access point (dial-up or ISP connection) and lower cost broadband channels can be used for the “last mile” connections. At a high level of security and access, the Private Meeting Group Site can be a destination access point on a virtual private network (VPN). This would allow the Private Meeting Group Site to be connected to the company intranet and other private access points on a shared data network, thereby allowing meeting participants controlled remote access to the company's databases and also access by users on the company intranet to participate in the online Meeting Group Site.

A VPN network typically consists of authenticated and encrypted tunnels over a shared data network. These are usually IP networks, the Internet being the most common example. The tunnels are set up between a network access point and a tunnel terminating device on the destination network. VPNs are commonly used by corporations looking to tunnel their corporate data through the Internet to provide network access. The function of the network access point is to encapsulate packets sent by the remote user so that the data travels securely over the shared network. Current implementations use different tunneling protocols depending on whether the data transfer is geared toward ISPs and has provisions for call origination and flow control, or to be initiated from a VPN-enabled client computer independent of the ISP. Data security may be provided at different levels of security with the accompanying overhead costs. A lightweight implementation, for example, provides strong authentication of each packet and ensures data integrity, while a higher-overhead implementation adds encryption of the data. Besides security, VPNs can provide large cost savings for remote users accessing a home network, since they will be able to gain ubiquitous local dial-up connectivity to distant networks at low cost.

Thus, in the preferred implementation of the invention, the Private Meeting Group Site is hosted on a network edge server in network proximity to the meeting location, and the edge server is set up as a destination access point on a VPN connected to the company intranet and/or private access points on the company shared data network. With some tradeoff in cost, this type of configuration would provide all the advantages of response speed, scalability, low access costs, data security, access by meeting participants to the company databases, and remote participation by company user in the meeting group site (including videoconferencing). The configuration of the edge server depends on how reliable and scalable the site needs to be with cost tradeoff as a limiting factor.

Access to the VPN can be given to other trusted parties that the CMP may want to have involved in the organization and execution of the meeting event. Particularly for large meetings of hundreds or thousands of attendees, providing access for the local destination management company and/or the hotel meeting (event) planner to the meeting group data and meeting facilitation functions would allow them to carry their functions much more readily and without laborious data re-entry. For example, hotel guest lists, meeting scheduling lists, activity participant lists, transportation and porterage manifest lists, etc., can all be accessed, updated, and printed out from the online Meeting Group Site. The site can also greatly facilitate real time communication between all of the parties. The site can also serve as the e-commerce hub for local bookings, transactions, and fulfillment of activities and purchases from the hotel, event host, third party providers and vendors.

Wireless access by meeting attendees to the Private Meeting Group Site can also be provided by enabling the site to communicate with switches for cellphones and other wireless devices using the Wireless Application Protocol (WAP). The WAP-enabled device would have to subscribe to a cellular service provider who has local coverage. In the future, advanced locally-based wireless networks can be set up, such as the short-range wireless system proposed by the Bluetooth consortium. As shown in FIG. 1, coordination of data flows between the 3 nodes of the invention system can be carried out by a system intermediary under control of the meeting planner. For example, if for security reasons it is desired that the ASP site not have access to the Private Meeting Group Site, the final meeting group program can be sent from the ASP site to the system intermediary, and from there downloaded to the Private Meeting Group Site by the meeting planner at the time that the sensitive data is downloaded from the Secure PC for the Private Meeting Group Site. The system intermediary can also perform access control functions for the VPN for data exchanges between the company shared data network and the Private Meeting Group Site. In the latter case, the system intermediary could be a network server on the corporate intranet.

TABLE I
Meeting Planner Software Features

| 1. | Data Entry to Meeting Group Database | |
|---|---|---|
| | A. | Allows entry into and maintains records of employees, vendor |
| | | contacts, service providers, associations, etc., and uses them as a |
| | | pool to populate a meeting group record. |
| | B. | “Last Contact” feature: allows instantaneous switching between |
| | | records. |
| 2. | Resource Browser for Selecting and Booking | |
| | Activities & Events for Meeting Group | |
| | A. | Accesses vendor-supplied resource information from within the |
| | | software, or by one-click access to the Internet. |
| | B. | Maintains multiple cost and sell types for cost/price comparison |
| | | (vendor guarantee, actual cost, client guarantee, bulk); maintains |
| | | multiple sell types for planned event comparisons (component |
| | | sell, activity sell, bulk sell). |
| | C. | Maintains pool of resources that may be required for a meeting |
| | | group (Transportation, Activities, Events, Food & Beverage, |
| | | Golf, Labor, Accommodations, etc.); allows selections for any of |
| | | the multiple sell pricing types; resources can be added to the |
| | | group resource browser singly, selectively or en masse. |
| | D. | Allows cloning of a resource, both in the main and group |
| | | resource browsers. |
| | F. | Maintains group resources for the group resource browser |
| | | independently of the main resources; group resources can be |
| | | modified for a particular group. |
| | G. | Include transportation services; passenger counts updated |
| | | automatically per user selection (All Pax, Transferred Pax, |
| | | None); automatically generates porterage costs, gratuity costs |
| | | and meet-and-greet costs for transportation movements. |
| | H. | Allows groupings of meeting participants together by arrival |
| | | data and departure data, and assigns appropriate transportation |
| | | based on those groupings. |
| 4. | Service Requests/Orders | |
| | A. | Generates detailed service requests for any vendor based on |
| | | entered data. |
| | B. | Tracks status of service requests, annotations, change orders, |
| | | replies. |
| | C. | Generates purchase confirmations and vouchers via e-mail in |
| | | real-time. |
| 5. | Export of Meeting Group Data | |
| | A. | Group database can be exported to online meeting group site for |
| | | use during meeting. |
| | B. | Extractor tools can be added to extract non-sensitive group data |
| | | for export to a public ASP site for further Internet resource |
| | | browsing and creating fully-featured meeting group program to |
| | | be used at online meeting group site; tools can be configured to |
| | | extract group demographic data, group preference data, non- |
| | | identifying member Ids (e.g., truncated email handles), etc. |
| | C. | Exported data can be formatted with XML markup types. |
| | D. | Group database can include records of any desired contacts, |
| | | vendors, associations, etc. for convenient access at online |
| | | meeting group site. |
| | E. | Exported database be returned from the field with modified data |
| | | for inclusion in the company's master or archive database. |
| | F. | Tools can be provided to integrate meeting group data with |
| | | externally-developed meeting group program installed at online |
| | | meeting group site. |
| 6. | Meeting Group Communications | |
| | A. | Generates personal itinerary for each group member, including |
| | | arrival, departure and booked activity information; itinerary |
| | | sent to each member via e-mail in real-time. |
| | B. | Includes communication functions and members directory to |
| | | allow communications at the online meeting group site, such as |
| | | e-mails, letters and messages, to be distributed to all members |
| | | of a group. |
| | C. | Automatically generates departure notices for group members |
| | | based on hotel and room numbers. |

1. An online meeting planning system comprising:
(a) a first node which is a secure computer protected from unauthorized access having a meeting planner application program for entering meeting planning data which includes: (i) personal, identifying, or other sensitive data of persons authorized as attendees at a meeting event; and (ii) non-sensitive group data which are unique to a group of authorized attendees at the meeting event and usable for meeting planning and other meeting facilitation functions for the group;
(b) a second node which is a public online site which receives only the non-sensitive group data uploaded from the first node and assembles meeting planning and other meeting facilitation functions in a unique meeting group program using the non-sensitive group data; and
(c) a third node which is a private online site which receives the assembled meeting group program downloaded from the second public node and the sensitive data of authorized attendees downloaded from the first secure node and combines the authorized attendee data together with the meeting group program to create a private meeting group site accessible only to authorized attendees of the meeting event.

2. An online meeting planning system according to claim 1, wherein the first node is a secure PC on a corporate intranet or standalone system behind a firewall which is used by a meeting planner to enter the sensitive data and non-sensitive group data for a planned meeting event, the second node is a public ASP site on the Internet which assembles meeting planning and meeting facilitation functions in the meeting group program as selected by the meeting planner, and the third node is a private meeting group site hosted on a local server in network proximity to the meeting location.

3. An online meeting planning method comprising:
(a) entering data at a secure computer protected from unauthorized access which includes: (i) personal, identifying, or other sensitive data of persons authorized as attendees at a meeting event; and (ii) non-sensitive group data which are unique to a group of authorized attendees at the meeting event and usable for meeting planning and other meeting facilitation functions for the group;
(b) uploading only non-sensitive group data from the entered data to a public online site for assembly of a unique meeting group program having meeting facilitation functions; and
(c) downloading the unique meeting group program from the public online site and combining it with sensitive data downloaded from the data entered at the secure computer to a private online site which is accessible only to authorized attendees of the meeting event.
